(19) United States
(12) Patent Application Publication
(10) Pub. No.: US 2008/0006228 A1
(43) Pub. Date: Jan. 10, 2008

(54) Liebe revolutionary engine

(76) Inventor: Forest Frank Liebe, Coeur d' Alene, ID (US)

Correspondence Address: FOREST FRANK LIEBE, 2812 N. 15TH, COEUR D' ALENE, ID, 83815, US

(21) Appl. No.: 11/480,643

(22) Filed: Jul. 5, 2006

(51) Int. Cl. F02F 1/34

(52) U.S. Cl. 123/41.6

(57) ABSTRACT

An engine that has expandable cylinders receives its pressure from a steam boiler or any other expanding, external gases, and/or liquid devices. The motor or pump is made of, encased, reciprocating spheres and toroidal cavities that are located in the outer wheels allowing said balls to cam in and out, rotating the said outer wheels. The steam, gases or liquid is presented under pressure at the intake sliding type valve of the motor and the cam action of the piston (balls) creates a closed chamber which causes the chambers (cylinders) to expand and the outer wheels to turn. A sliding exhaust valve then opens up to expel the expended material (steam) aided by the balls. The balls are then cammed to the opposite side creating a seal for that chamber and the action repeats. A pressurized lubricant is introduced via the ball tubes enhancing the chamber seals. The outer wheels are surfaced to the middle block at a close tolerance to make a lubricated seal.

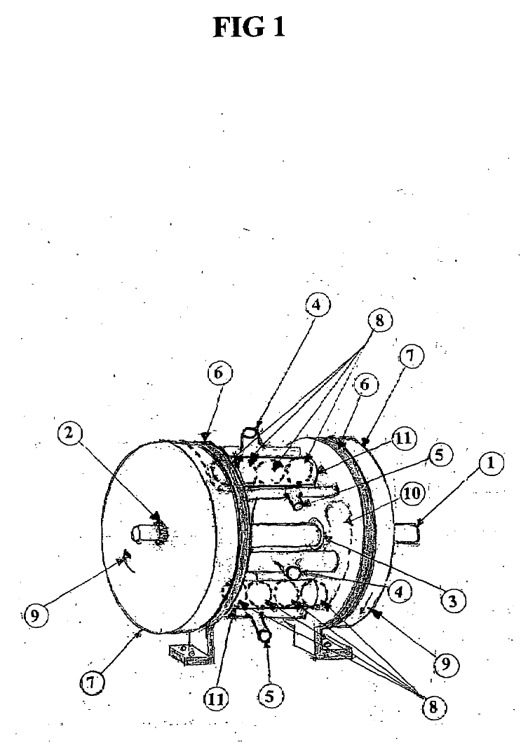

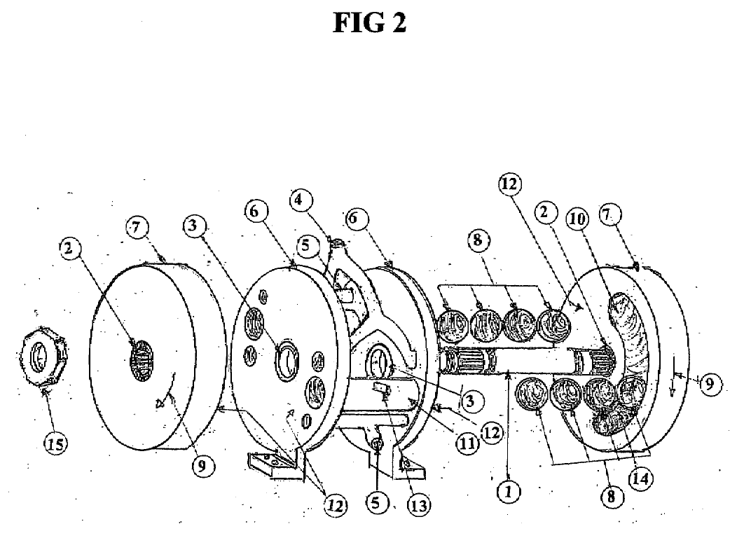

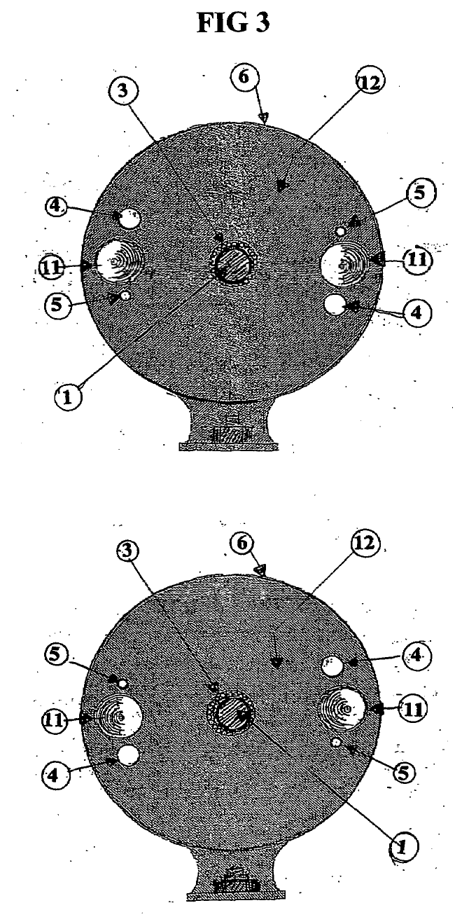

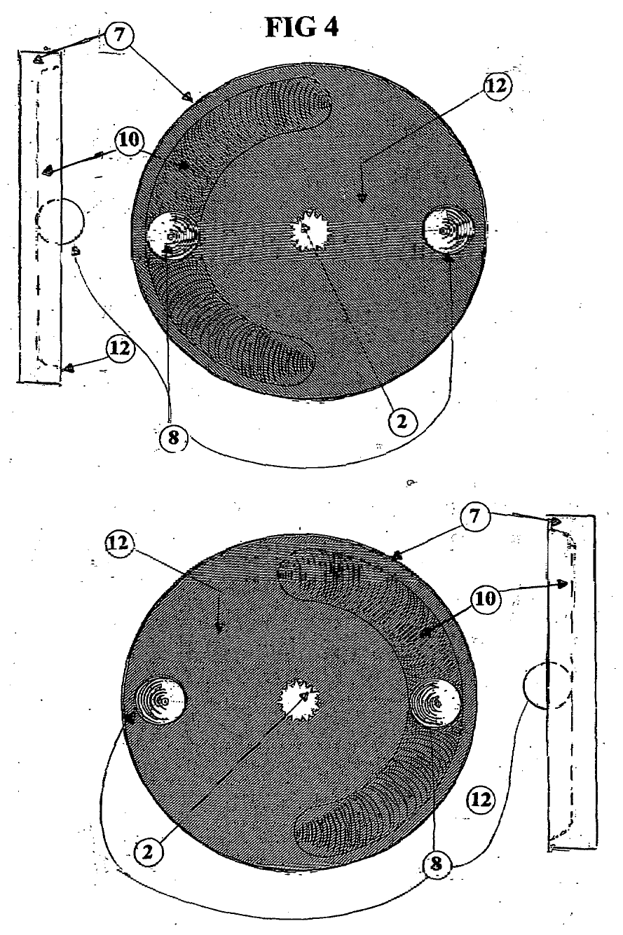

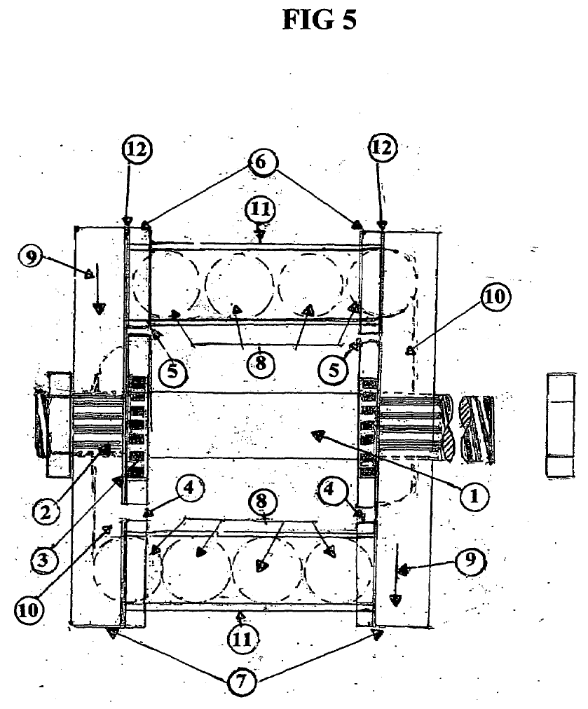

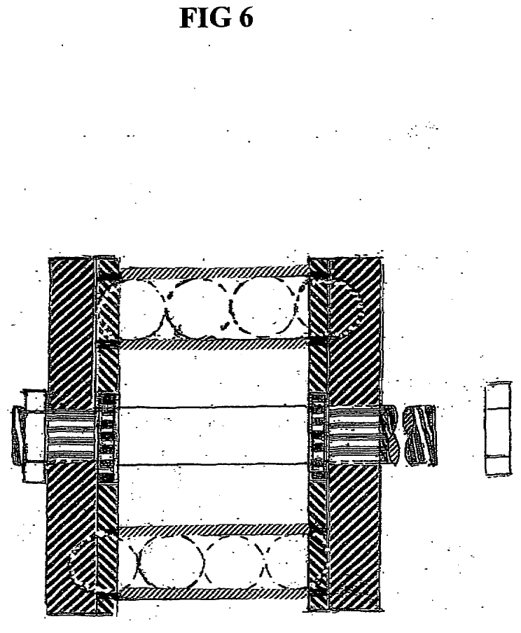

The invention is in the field of extracting work from expanding gases or liquid under pressure.

The engine has 11 moving parts that are easily assembled and disassembled and is comprised of a center block consisting of two separate mounted plates that have two (2) fixed tubes each holding four (4) balls rolling against the other. A center drive shaft is mounted with two (2) roller bearings fixed on each plate of the block.

The block plates are spaced apart at a measured distance so that, of the 4 balls in each tube, only one half of a ball protrudes on one side of said block. The second tube has one half of one ball protruding on the opposite side. These one half balls serve as sealing pistons for the toroidal cavities that are carved into the inside rotating wheels creating expandable cylinders set at 180 degrees from each other. The rotating wheels are splined with the driveshaft and turn as one unit. This is held at a set pressure by two fixed nuts on each end.

The outsides of the block and the inside of the rotating wheels are surfaced such that, with the aid of lubricants from the balls and other sources, form a seal.

The manifolds are attached to the inside of each block plate consisting of four intake ports.

As the outside wheels turn the balls, by camming action, enter and seal off the torodial chambers. In sequence the intake ports open to the expanding cylinders by sliding valve action. The pressurized gas then enters the expandable cylinder turning the wheels in a curved direction away from the fixed balls that are held in place by cylindrical tubes.

As the expandable cylinder continues the intake port is closed and the exhaust port opens and the balls aid in cleaning out the exhaust port. The sequence action is repeated for each ball and cylinder as the wheel turns. This action occurs 4 times for every revolution, creating a constant pressure application on the said turning wheels.

What is claimed is:

1. A steam or other high pressure gas and/or liquid operated engine consisting of a minimal of parts with ease of manufacturing, assembly and disassembly. The parts consist of spherical balls that serve as pistons incased in tubes with a cam reciprocating action to the torodial expanding cylinders creating a closed chamber for said gas and or liquid to apply power to the center drive shaft.

2. Can also be used as a pump by applying external power to the drive shaft.

3. This engine is efficient and powerful and produces little or no pollution that can harm the environment. It can be applied to both stationary and or mobile locations.
